(19) United States
(12) Patent Application Publication
(10) Pub. No.: US 2025/0078118 A1
(43) Pub. Date: Mar. 6, 2025

(54) METHOD OF CONTROLLING SERVER LINKED TO USER TERMINAL OF USER CARRYING ADVERTISING DISPLAY DEVICE

(71) Applicant: ACKLO CORP., Suwonsi, Gyeonggi-do (KR)

(72) Inventor: In Young KWON, Seoul (KR)

(73) Assignee: ACKLO CORP., Suwonsi, Gyeonggi-do (KR)

(21) Appl. No.: 18/557,940

(22) PCT Filed: Jun. 23, 2023
(86) PCT No.: PCT/KR2023/008727

§ 371 Date: Oct. 29, 2023

(30) Foreign Application Priority Data
Oct. 24, 2022 (KR) 10-2022-0137498

(51) Int. Cl. G06Q 30/0251; G01C 21/34; G06Q 30/0207

(52) U.S. Cl. CPC G06Q 30/0266; G01C 21/3407; G06Q 30/0225

(57) ABSTRACT

Provided is a method of controlling a server that communicates with a user terminal of a user who carries a display device outputting an advertisement. The method includes: obtaining, by the server, at least one candidate route based on real-time data related to a location of the user terminal and a zone-specific floating population; transmitting, by the server, information about the candidate route to the user terminal; and upon receiving a user input for selecting the candidate route as a target route, generating, by the server, a mission for the user based on the target route and at least one advertisement registered for a zone including at least a part of the target route.

### TECHNICAL FIELD

The present disclosure relates to a method of controlling a server that provides an advertising platform, and more specifically, to a method of controlling a server that supports and monitors a user who moves while carrying a display device that outputs an advertisement.

### BACKGROUND ART

With the print advertising industry clearly showing a downward trend, the advertising market is being reorganized to focus on digital.

However, for advertising that is entirely provided through digital content, there are limitations on the types of available channels and the entry barrier is already very high.

Therefore, there is a need for a completely new type of advertising paradigm that can overcome the increasing trend of emphasizing non-face-to-face interactions and the limited digital content channels.

### DISCLOSURE

### Technical Problem

The present disclosure is directed to providing a method of controlling a server that provides a new advertising platform that combines the output of digital content and offline advertising.

The technical objectives of the present invention are not limited to the above, and other objectives that are not described above may become apparent to those of ordinary skill in the art based on the following descriptions.

### Technical Solution

One aspect of the present disclosure provides a method of controlling a server that communicates with a user terminal of a user who carries a display device outputting an advertisement, the method including: obtaining, by the server, at least one candidate route based on real-time data related to a location of the user terminal and a zone-specific floating population; transmitting, by the server, information about the candidate route to the user terminal; upon receiving a user input for selecting the candidate route as a target route, generating, by the server, a mission for the user based on the target route and at least one advertisement registered for a zone including at least a part of the target route; and when the mission for the user is generated, outputting, by the server, the advertisement through the display device.

The method may include: in a case when the user terminal reaches a destination of the target route while the advertisement is displayed, identifying the mission as being completed; and when the mission is identified as completed, registering a reward matching the mission for the user.

The method may include, in a case when the display device is located a certain distance or more away from the location of the user terminal while the generated mission is not completed, registering a penalty for the user.

The method may include: updating reliability of the user based on the penalty; setting a maximum movement distance related to mission performance of the user based on the reliability; and transmitting information about at least one candidate route shorter than the maximum movement distance to the user terminal.

The method may include transmitting, by the server, information about a plurality of advertisements registered for the zone including the at least a part of the target route to the user terminal, wherein the generating of the mission may include generating the mission based on the selected advertisement and the target route according to a user input for selecting at least one advertisement among the plurality of advertisements.

The obtaining of the candidate route may include obtaining at least one candidate path based on a current location of the user terminal, a current time, and a time-specific floating population for each zone.

The method may include identifying, by the server, locations of a plurality of users performing missions in real time. The obtaining of the candidate route may include obtaining a candidate route for the user based on a zone-specific floating population and the respective locations of the plurality of users.

The method may include receiving, by the server, data on a floating population in real time from a plurality of store terminals of a plurality of stores included in each zone.

One aspect of the present disclosure provides a method of controlling a user terminal, the method including: obtaining, by the user terminal, at least one candidate route based on real-time data related to a location of the user terminal and a zone-specific floating population; providing, by the user terminal, information about the candidate route; and upon receiving a user input for selecting the candidate route as a target route from a user, generating, by the user terminal, a mission for the user based on the target route and at least one advertisement registered for a zone including at least a part of the target route.

One aspect of the present disclosure provides a system for providing an advertising platform, the system including: a display device that outputs an advertisement; and a server that communicates with the display device and communicates with a user terminal of a user carrying the display device, wherein the server is configured to: obtain at least one candidate route based on real-time data related to a location of the user terminal and a zone-specific floating population; transmit information about the candidate route to the user terminal; and upon receiving a user input for selecting the candidate route as a target route, generate a mission for the user based on the target route and at least one advertisement registered for a zone including at least a part of the target route; and when the mission for the user is generated, output the advertisement through the display device.

### Advantageous Effects

A method of controlling a server according to the present disclosure is provided to support an advertising platform that combines the portability of a display device and the convenience of manipulation of a user terminal, in which a user providing an advertisement rents a display device at a desired time and moves by walking or the like to complete a mission, thereby presenting a new advertising paradigm that can benefit both advertisers and users.

### DESCRIPTION OF DRAWINGS

FIG. 1 is a diagram for describing the operation of a server for communicating with a display device of a user and a user terminal according to an embodiment of the present disclosure.

FIG. 2 is a flowchart for describing an operation in which a server generates a mission based on the location of a user and a floating population according to an embodiment of the present disclosure.

FIG. 3 is a diagram for describing an operation in which a server recommends a candidate route for a user through a user terminal according to an embodiment of the present disclosure.

FIG. 4 is a diagram for describing an operation in which a server performs a series of processes from registering an advertisement by an advertiser to outputting an advertisement by a display device according to an embodiment of the present disclosure.

FIG. 5 is an algorithm for describing an operation in which a server generates a penalty and/or reward based on various types of data related to the location of a user performing a mission according to an embodiment of the present disclosure.

FIG. 6 is a diagram illustrating an example in which, unlike the embodiments of the above-described drawings in which users move on foot, users moving on various modes of transportation are registered and advertisements are output through a display device provided in the transportation.

### MODES OF THE DISCLOSURE

Before describing the present disclosure in detail, a description method of the specification and drawings will be explained.

First, terms used in the present specification and claims have been selected as general terms in consideration of the functions in various embodiments of the present disclosure. However, these terms may be changed according to the intention of a person skilled in the art, a legal or technical interpretation, and the advent of new technology. Also, some terms are arbitrarily selected by the applicant. These terms may be interpreted as defined in the present specification, and if there is no specific definition of the term, it may be interpreted based on the overall content of the present specification and common technical knowledge in the art.

Also, the same reference numerals or reference signs in the drawings attached to this specification indicate parts or components that perform substantially the same functions. For convenience of description and understanding, different embodiments may be described using the same reference numerals or reference signs. That is, even when all components having the same reference number are illustrated in a plurality of drawings, the plurality of drawings do not represent one embodiment.

Also, in the specification and claims, terms including ordinal numbers, such as “first,” “second,” etc. may be used to distinguish one component from another. These ordinal numbers are used to distinguish identical or similar components from each other, and the meaning of the term should not be interpreted limitedly by the use of these ordinal numbers. For example, the order of use or arrangement of components combined with these ordinal numbers should not be limited by the number. If necessary, each ordinal number may be used interchangeably.

In this specification, it should be understood that the singular forms “a” and “an” also include the plural forms unless the context clearly dictates otherwise. The terms “comprises,” “comprising,” “includes,” and/or “including” used herein specify the presence of stated components, steps, operations and/or elements thereof and do not preclude the presence or addition of one or more other components, steps, operations and/or elements thereof.

In an embodiment of the present disclosure, terms such as “module,” “unit,” “part,” etc. are terms for specifying a component that performs at least one function or operation, and such component may be implemented by hardware or software or implemented as a combination of hardware and software. In addition, a plurality of “modules,” “units,” “parts,” etc. may be integrated into at least one module or chip as at least one processor, except when each needs to be implemented as individual specific hardware.

Also, in an embodiment of the present disclosure, it should be understood that when a first part is referred to as being “connected” to a second part, the first part may be directly connected to the second part or indirectly connected to the other part with intervening elements. The meaning that a part includes a certain component does not mean other components are excluded, but rather other components are included, unless the context dictates otherwise.

Hereinafter, various embodiments of the present invention will be described in detail using the accompanying drawings.

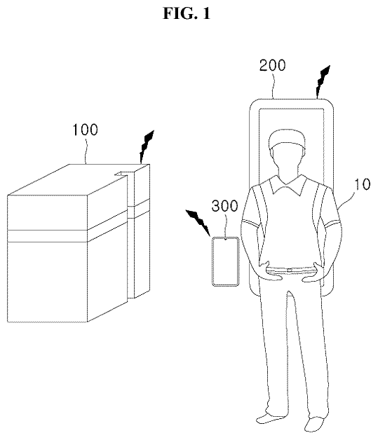

FIG. 1 is a diagram for describing the operation of a server for communicating with a display device of a user and a user terminal according to an embodiment of the present disclosure.

Referring to FIG. 1, a server 100 may communicate with a display device 200 and a user terminal 300 of at least one user 10.

The server 100 is a device of a service provider that operates an advertising platform according to the present disclosure, and may communicate with the display device 200 and the user terminal 300 through at least one application and/or web page.

The server 100 may be composed of at least one computer or system.

The server 100 may include a memory, a communicator, a processor, and the like.

The memory is a component to store an operating system (OS) for controlling the overall operation of components within the server, at least one instruction, and data. The memory may include non-volatile memories, such as a read-only memory (ROM), a flash memory, and the like, and may include volatile memories including a dynamic RAM (DRAM) and the like. In addition, the memory may include a hard disk, a solid state drive (SSD), and the like.

The communicator may include at least one circuit or module for communicating with various external devices. The communicator may be connected to external devices based on a network implemented through wired communication and/or wireless communication. In this case, the communicator may be directly connected to the external device, but may also be connected to the external electronic device through one or more external servers, e.g., an Internet service provider (ISP) that provide a network. Depending on the area or size, the network may be a personal area network (PAN), a local area network (LAN), or a wide area network (WAN). Depending on the openness of the network, the network may be an intranet, an extranet, or the Internet. Wireless communication may include at least one of communication methods among Long-Term Evolution (LTE), LTE Advance (LTE-A), 5th Generation (5G) mobile communication, code division multiple access (CDMA), wideband code division multiple access (WCDMA), universal mobile telecommunications system (UMTS), wireless broadband (WiBro), global system for mobile communications (GSM), time division multiple access (TDMA), Wi-Fi, WiFi Direct, Bluetooth, near field communication (NFC), and Zigbee. Wired communication may include at least one of communication methods, such as Ethernet, optical networks, universal serial bus (USB), and Thunderbolt. The communicator may include a network interface or a network chip according to the wired or wireless communication method described above. Meanwhile, the communication method is not limited to the examples described above and may include newly emerging communication methods according to development of technology.

The processor is a component for overall control of each component included in the server, and may control the operation of the server according to various embodiments that will be described below. The processor may include various units, such as a central processing unit (CPU), an application processor (AP), a graphics processing unit (GPU), a visual processing unit (VPU), and a neural processing unit (NPU). The processor 120 may execute instructions stored in the memory, thereby controlling the server.

The display device 200 is a component for outputting advertisement information within an advertising platform according to the present disclosure. The display device 200 may include at least one carrying member (e.g., a shoulder strap, a waist strap, a handle, and the like) that allows the user 10 moving on foot to carry the display device 200. While the user 10 carrying the display device 200 moves, the display device 200 may display an image corresponding to an advertisement.

Specifically, in a state in which the user 10 wears the shoulder strap of the display device 200, the display device 200 may have a rear side oriented to face the back of the user 10 and a front side provided with a display for displaying an advertisement. As a result, people located around the moving user 10 may see the advertisement displayed by the display device 200.

The display device 200 may be operated in such a way that the user 10 rents the display device 200 from a service provider, or the user 10 directly owns the display device 200 (e. g., the display device 200 originally owned by the user 10 is registered on the platform and used, or the user 10 completely purchases the display device 200 provided by a service provider).

The display device 200 may include a display in addition to a memory, a communicator, and a processor, and may additionally include an audio output device, such as a speaker and the like. The display may be implemented as a liquid crystal display (LCD), a light emitting diode (LED), an organic light emitting diode (OLED), a transparent OLE (TOLED), a Micro LED, and the like. In addition, the display 110 may be implemented as a curved display, a flexible display, a foldable display, and the like in addition to a flat display. In addition, the display 110 may be implemented as a three-dimensional (3D) holographic display, and in this case, the display device 200 may include at least one backlight, and the display 110 may have at least one slit for diffraction of light.

The user terminal 300 may correspond to a terminal device of a user and may correspond to various portable terminal devices, such as a smartphone, a tablet personal computer (PC), a wearable device, and the like. The user terminal 300 may include a memory, a communicator, a processor, a display, a user inputter (e.g., a button, a touch pad, a microphone, a camera, and the like).

Meanwhile, before providing an advertisement through the display device 200 carried by the user according to embodiments to be described below, the server 100 needs to register the user terminal 300 of the user and the display device 200 so that the user terminal 300 of the user and the display device 200 are linked to each other.

First, the server 100 may obtain information about the user and information about the user terminal 300 according to a user input received through the user terminal 300. Here, the server 100 may support functions, such as membership registration and login based on a name, an ID, a password, and other personal information of a user. In addition, the server 100 may register a user by registering identification information of the user terminal 300 or a phone number of the user in the registration process.

For example, a registered user may rent at least one display device from at least one offline rental point that is operated directly/indirectly by a service provider.

In a state in which a user has rented at least one display device 200 as described above, the server 100 may register identification information of the display device 200 in association with the user according to a user input received through the user terminal 300.

Specifically, in a state in which a user is logged in, the user may enter identification information (e.g., a device number, a region, a rental point, and the like) of the display device 200 that he or she has rented, and a series of authentication processes may be performed.

As an example of the authentication process, the server 100 may, in response to rental of the display device 200 being performed, transmit an authentication number to the display device 200 at the request of the rental point (a terminal/computer of an administrator), and then in response to a specific number being obtained according to a user input received through the user terminal 300, check whether the above-described specific number matches the authentication number.

As the above-described authentication process is performed, the display device 200 may be registered for the user, and in this case, the registration may be valid for a certain period of time. That is, a return period may be automatically set. In this case, the return period may correspond to a certain period of time from the start of the rental, in which the certain period of time may be a preset period and may vary depending on the rental option.

In response to the display device 200 being registered for the user terminal 300, the server 100 may transmit information about one or more missions to the user terminal 300.

The mission refers to a series of targeted actions of moving along a target route while carrying a display device that displays an advertisement. For example, the platform may be operated in such a way that when a user 10 completes a mission, a reward matching the mission is given to the user 10.

The information about the mission may include information about each of an advertisement and a target route that are to be output. Specifically, the information about the mission may include a name/title of an advertiser, an advertised product/service, advertising content, and the like. In addition, the information about the mission may include information about a zone or region for which the corresponding advertisement is registered. In addition, the information about the mission may include a starting point, a destination point, a specific route, a distance, an expected required time, and the like of the target route on which the corresponding advertisement is displayed.

In addition, the information about the mission may include information about a target time slot (e.g., between 11 AM and 2 PM) in which the mission needs to be performed, an expiration time of the mission (e.g., completion by 6 PM on October 15), and the like.

As an example, the server 100 may transmit information about a plurality of missions to the user terminal 300, and a mission selected according to a user input received through the user terminal 300 may be assigned/generated to/for the user 10.

Meanwhile, the server 100 according to the embodiment of the present disclosure may generate at least one mission in real time based on the location of the user.

For example, the server 100 may recommend at least one candidate route suitable for the location of the user and generate a mission according to a user's selection of the recommended candidate route and assign the generated mission. Details thereof will be described below with reference to drawings.

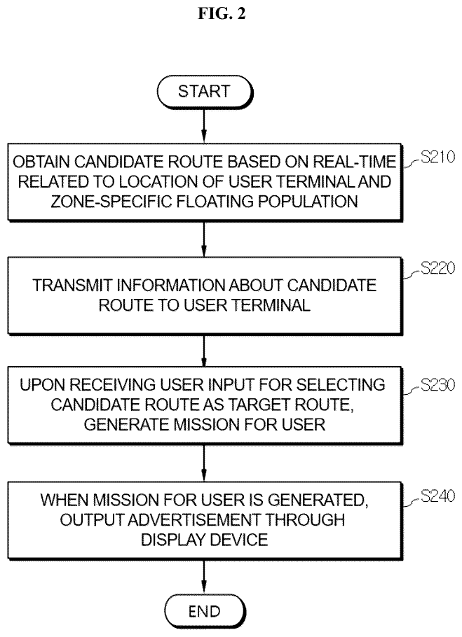

FIG. 2 is a flowchart for describing an operation in which a server generates a mission based on the location of a user and a floating population according to an embodiment of the present disclosure.

Referring to FIG. 2, the server 100 may obtain at least one candidate route based on real-time data related to a location of a user terminal and a floating population for each zone (S210).

Specifically, the server 100 may obtain at least one candidate route based on a current location of the user terminal 300, a current time, and a time slot-specific (or real-time) floating population for each zone.

The server 100 may identify the location of the user based on location information (e.g., global positioning system (GPS) information) received from the user terminal 300. Alternatively, the server 100 may receive identification information of at least one relay device (e.g., a Wi-Fi router) connected to the user terminal 300 from the user terminal 300, and determine the location of the relay device according to the identification information of the relay device to identify the corresponding location as a real-time location of the user. Alternatively, the server 100 may identify the location of the user based on location information (e.g., GPS information) of the display device 200 rather than that of the user terminal 300.

The time slot-specific floating population may be already registered on the server 100 for at least one zone including a point at which the user 10 is located or zones adjacent to the corresponding zone. To this end, the server 100 may receive data on the time slot-specific floating population for each zone from at least one external server (e.g., a telecommunication company server) that manages/monitors big data related to the time slot-specific floating population.

Alternatively, the server 100 may receive data on the floating population in real time from store terminals of a plurality of stores included in each zone. For example, the server 100 may receive, from store terminals in each store, data related to the number of users using each store (e.g., the number of people entering/exiting the store, the number of people making a payment, and the number of people who have transmitted a waiting request (via a smartphone app, etc.) for entering the store) in real time. In this case, the server 100 may predict the floating population of the entire zone in real time based on data related to each of the plurality of stores included in the zone. To this end, the server 100 may utilize at least one artificial intelligence (AI) model (e.g., a recurrent neural network (RNN) model) trained based on the past time slot-specific floating population of the entire zone and number of users of each store for each time slot.

The server 100 may select at least one zone that is within a certain distance from the current location of the user 10 and has a floating population greater than or equal to a certain level as of the current time.

In this case, the server 100 may automatically generate at least one candidate route that passes through the selected zone while having the current location of the user 10 as a starting point.

Here, the server 100 may select a candidate route that passes through a zone that does not overlap the locations of other users performing missions as much as possible. Specifically, the server 100 may identify the location of each of the plurality of users performing missions in real time, and may obtain a candidate route for the user based on the floating population for each zone and the location of each of the plurality of users. In this case, the candidate route corresponds to a route that passes through a zone with as much floating population as possible but does not overlap the locations of other users (or the target routes of missions being performed by other users) as much as possible.

In this regard, the server 100 may use at least one AI model to generate a candidate route. Specifically, the server 100 may input the current location of the user, the current floating population for each zone, and the current locations of other users performing missions into the AI model, and the AI model may automatically generate a candidate route and output the generated candidate route.

The AI model for generating candidate routes may be a model trained based on various machine learning algorithms, such as a decision tree, a support vector machine (SVM), random forest (RF), and the like. Alternatively, the AI model may be a neural network model trained/updated based on weights between nodes of different layers.

The AI model for generating candidate routes may be a model trained based on the results of actual human selections according to the value of each item (a current location of a user, a current floating population for each zone, and current locations of other users performing missions). Alternatively, the AI model for generating candidate routes may be a model trained through a plurality of determination processes by receiving feedback in a direction to increase a result value (e.g., a floating population encountered on a candidate route and a distance from other users performing missions) that is derived by applying a candidate route generated by the AI model.

When a candidate route is generated according to at least one of the above-described embodiments, the server 100 may transmit information about the candidate route to the user terminal (S220, recommendation of a route).

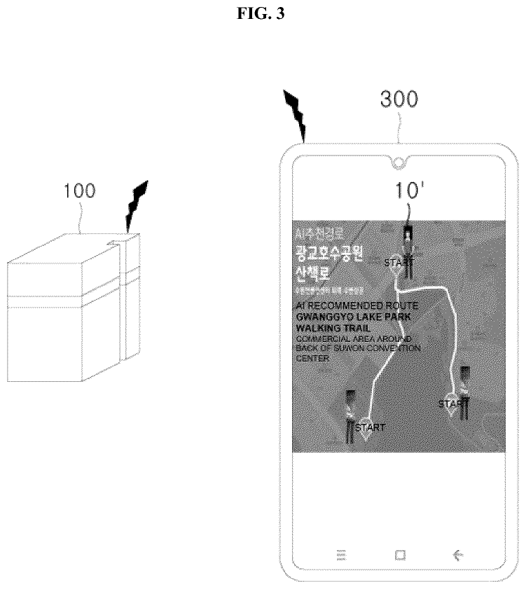

In this regard, FIG. 3 is a diagram for describing an operation in which a server recommends a candidate route for a user through a user terminal according to an embodiment of the present disclosure;

Referring to FIG. 3, the server 100 may output a map including a candidate route (e.g., an AI recommended route) along with a virtual character 10′ representing the user 10 through the user terminal 300. In this case, the distance and the expected required time for the candidate route may also be provided.

In addition, when a user input for selecting the candidate route as a target route is received, the server 100 may generate a mission for the user based on the target route and at least one advertisement registered for a zone including at least a part of the target route (S230).

Specifically, the server 100 may provide the user terminal 300 with information about a plurality of advertisements registered for a zone including at least a part of the target route, and based on the target route and an advertisement selected according to a user input, generate/assign a mission for/to the user.

When the mission for the user is generated, the server 100 may output the corresponding advertisement through the display device 200 (S240). Specifically, the server 100 may transmit an output request including image data and/or audio data constituting the advertisement to the display device 200.

Meanwhile, at least some of the above-described series of processes, such as obtaining a candidate route and generating a user's mission, may be performed directly through the user terminal 300. Specifically, the user terminal 300 may obtain a candidate route based on the location of the user terminal 300 and the floating population for each zone (e. g, using AI), and provide the candidate route to the user. In addition, the user terminal 300 may directly generate a mission for the user according to a user's input for selecting a candidate route and register the mission on the server 100. As a result, an advertisement may be output through the display device 200.

Meanwhile, advertisements included in the mission may be advertisements requested from various advertisers, and each of the advertisements may be requested by specifying at least one zone.

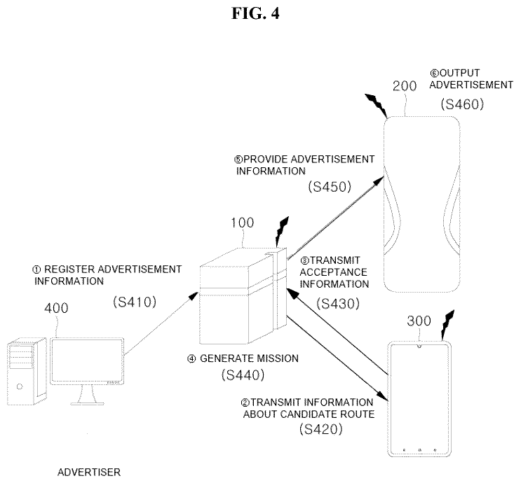

In this regard, FIG. 4 is a diagram for describing an operation in which a server performs a series of processes from registering an advertisement of an advertiser to outputting the advertisement on a display device according to an embodiment of the present disclosure.

Referring to FIG. 4, the server 100 may register advertisement information received from an advertiser terminal 400 of an advertiser (S410). The advertisement information may include content (image data and audio data) of an advertisement, a target product of an advertisement, and the like. In addition, the server 100 may set a zone/region targeted for advertising, an advertising period, an advertising frequency, an advertising time slot, and the like according to an advertiser's input received through the advertiser terminal 400. In this case, the greater the number of zones/regions targeted for advertising or the wider the area, the more zones/regions with a greater floating population are selected, and the longer the advertising period, the higher the advertising frequency, the higher the advertising costs are calculated. Based on the advertising costs spent by the advertiser, the reward paid to the user who performs the mission for the advertisement may be covered.

In response to an advertisement being registered, the server 100 may generate/assign a mission for/to at least one user.

Specifically, the server 100 may select at least one user (e.g., a user 10) located in a zone/region targeted by a registered advertisement or at least one user (e. g., a user 10) located adjacent to a zone/region targeted by a registered advertisement.

In this case, the server 100 may generate a candidate route based on the location of the user and the floating population for each zone and transmit the generated candidate route to the user terminal 300 (S420). In response to receiving acceptance information of a user for selecting the candidate route recommended by the server 100 as described above (S430), the server 100 may assign/generate a mission to/for the user 10, which is composed of the registered advertisement and the target route (the selected candidate route).

When the mission is generated, the server 100 may transmit advertisement information, specifically, advertisement content, to the display device 200 registered for the user 10 (S450). As a result, the display device 200 may display an image of the advertisement (S460) and when there is audio data, may also output sound.

In a case when the user terminal 300 reaches the destination point of the target route while the advertisement is displayed through the display device 200, the server 100 may identify that the corresponding mission has been completed. In this case, the server 100 may register a reward that matches the mission for the user and may transmit a request to stop displaying the advertisement from the display device 200 to the display device 200.

Meanwhile, while a mission is being performed, the server 100 may monitor mission performance of the mission based on various pieces of data related to the location of the user and register rewards/penalties.

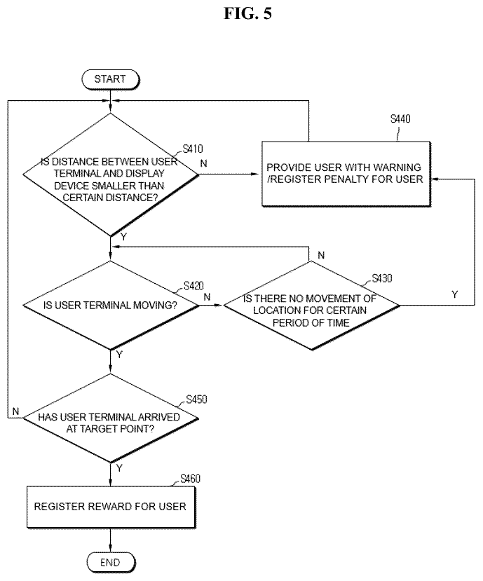

In this regard, FIG. 5 is an algorithm for describing an operation in which a server generates a penalty and/or reward based on various types of data related to the location of a user performing a mission according to an embodiment of the present disclosure. FIG. 5 assumes a situation in which a mission is assigned to a user and started.

Referring to FIG. 5, during execution of a mission, the server 100 may monitor whether the distance between the user terminal 300 and the display device 200 is smaller than a certain distance (S410).

In addition, the server 100 may monitor whether the user terminal 300 is moving based on a real-time location of the user terminal 300 (S420). In this case, the server 100 may determine whether the user terminal 300 is moving based on real-time GPS information of the user terminal 300 or by receiving sensing data measured through an acceleration sensor and the like of the user terminal 300.

In a case when the distance between the user terminal 300 and the display device 200 is greater than or equal to the certain distance (NO in S410), the server 100 may provide a warning to the user or register a penalty for the user. This reflects the fact that when the user's movement is unrelated to an advertisement output (the display device 200), the mission is not considered to be normally performed.

For example, the penalty/reward may operate in such a way that a penalty is given when a certain number of warnings are accumulated.

In addition, even in a case when there is no movement of the user terminal 300 from a stationary state for a certain period of time (NO in S420, YES in S430), the server 100 may provide a warning to the user or register a penalty for the user.

In response to a warning and/or penalty being registered (S440), a certain waiting time may be given, and the process may return to S410.

However, in a case when the user terminal 300 moves while maintaining the certain distance from the display device 200 and arrives at the target point (YES in S450), the server 100 may generate/register a reward for the user terminal 300 (S460).

Meanwhile, the above-described penalty may be used to update the reliability of the user 10. Specifically, the server 100 may, based on the penalty given to each user, the reliability of the user may be decreased and updated. However, the reliability of each user may be increased and updated depending on the number of missions completed, the registered rewards, and the like.

The reliability represents the degree of expectation that a user can successfully perform a mission, and may be a criterion for determining to add or reduce the benefits provided to each user.

In an embodiment, the server 100 may set the maximum moving distance related to the mission performance of a user based on the reliability. In other words, the server 100 may assign a mission composed of a longer target route to a user with higher reliability, and a user having reliability lower than a certain level may be prevented from performing a mission that corresponds to a target route with a certain distance or more.

As a result, even when the server 100 generates a candidate route for the corresponding user (e.g., a user 10), the server 100 may generate at least one candidate route shorter than the maximum moving distance set for the user 10 and transmit the generated candidate route to the user terminal 300. For example, even when the AI model for generating candidate routes primarily generates a relatively long route, the server 100 may extract only some routes corresponding to the maximum moving distance from the primarily generated route and select the routes as candidate routes.

In an embodiment, the server 100 may grant a user a choice regarding advertisements based on reliability. For example, for a user having reliability lower than a certain level, the server 100 may randomly select an advertisement that matches the location of the user and generate a mission. On the other hand, for a user having reliability higher than or equal to the certain level, the server 100 may provide information about a plurality of advertisements matching the location of the user to the user terminal 300, and may generate a mission based on an advertisement selected from the plurality of advertisements.

In addition, as an embodiment, the server 100 may set the “certain time” in the above described operation S430 of FIG. 5 to be higher for a user with higher reliability. In addition, as an embodiment, the server 100 may set the “certain distance” in the above described operation S410 of FIG. 5 to be greater for a user with higher reliability. In other words, a user with higher reliability may be given a longer waiting time while moving, and may also have a more flexible movement radius set based on the location of the display device 200.

As described above, various benefits or restrictions are given to a user depending on the reliability of the user, and thus management based on objective indicators may be performed on users registered on the platform according to the present disclosure, and the sincerity of each user may be monitored and motivation may be provided.

Meanwhile, in addition to a user moving on foot (e.g., a user 10), the platform according to the present disclosure may be operated through a user moving on various modes of transportations.

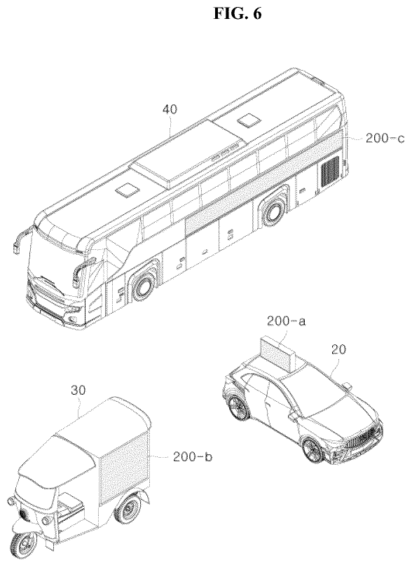

In this regard, referring to FIG. 6, the server 100 may register users who operate various modes of transportation, such as a vehicle 20, an electric bicycle 30, and a bus 40, and output advertisements through display devices 200-a, 200-b, and 200-c attached to the modes of transportation of the users based on information about missions assigned to the users.

Meanwhile, two or more of the above described various embodiments may be implemented together as long as they do not conflict with each other.

Meanwhile, the above described various embodiments may be implemented in a recording medium that may be read by a computer or similar device using software, hardware, or a combination thereof.

According to hardware implementation, the embodiments described in the present disclosure may be implemented using at least one of: application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and other electronic units designed to perform the functions described above.

In some cases, embodiments described herein may be implemented by a processor itself. According to software implementation, embodiments such as procedures and functions described in this specification may be implemented by separate software modules. Each of the software modules described above may perform one or more functions and operations described herein.

Meanwhile, computer instructions for performing processing operations of a server or terminal according to the above described various embodiments of the present disclosure may be stored in a non-transitory computer-readable medium. The computer instructions stored in the non-transitory computer-readable media, when executed by a processor of a specific device, cause the device to perform processing operations of the server and the like according to the above described various embodiments.

A non-transitory readable medium refers to a medium that can store data semi-permanently and can be read by a device, rather than a medium that stores data for a short period of time, such as registers, cache, and memory. Specifically, the above described various applications or programs may be provided by being stored in a non-transitory readable media, such as such as a compact disc (CD), a digital versatile disc (DVD), a hard disk, a Blu-ray disk, a USB, a memory card, a read-only memory (ROM), and the like.

While the present invention has been particularly shown and described with reference to exemplary embodiments thereof, it is to be understood that the invention is not limited to the disclosed exemplary embodiments, but, on the contrary, it will be understood by those skilled in the art that various changes and modifications may be made without departing from the spirit and scope of the present invention.

### MODE FOR THE INVENTION

A method of controlling a server that communicates with a user terminal of a user who carries a display device outputting an advertisement is disclosed. The method includes: obtaining, by the server, at least one candidate route based on real-time data related to a location of the user terminal and a zone-specific floating population; transmitting, by the server, information about the candidate route to the user terminal; and upon receiving a user input for selecting the candidate route as a target route, generating, by the server, a mission for the user based on the target route and at least one advertisement registered for a zone including at least a part of the target route.

### INDUSTRIAL APPLICABILITY

A method of controlling a server according to the present disclosure is provided to support an advertising platform that combines the portability of a display device and the convenience of manipulation of a user terminal, in which a user providing an advertisement rents a display device at a desired time and moves by walking or the like to complete a mission, thereby presenting a new advertising paradigm that can benefit both advertisers and users.

1. A method of controlling a server that communicates with a user terminal of a user who carries a display device outputting an advertisement, the method comprising:
obtaining, by the server, at least one candidate route based on real-time data related to a location of the user terminal and a zone-specific floating population;
transmitting, by the server, information about the candidate route to the user terminal;
upon receiving a user input for selecting the candidate route as a target route, generating, by the server, a mission for the user based on the target route and at least one advertisement registered for a zone including at least a part of the target route; and
when the mission for the user is generated, outputting, by the server, the advertisement through the display device.

2. The method of claim 1, comprising:
in a case when the user terminal reaches a destination of the target route while the advertisement is displayed, identifying the mission as being completed; and
when the mission is identified as completed, registering a reward matching the mission for the user.

3. The method of claim 1, comprising, in a case when the display device is located a certain distance or more away from the location of the user terminal while the generated mission is not completed, registering a penalty for the user.

4. The method of claim 1, comprising:
updating reliability of the user based on the penalty;
setting a maximum movement distance related to mission performance of the user based on the reliability; and
transmitting information about at least one candidate route shorter than the maximum movement distance to the user terminal.

5. The method of claim 1, comprising transmitting, by the server, information about a plurality of advertisements registered for the zone including the at least a part of the target route to the user terminal,
wherein the generating of the mission includes generating the mission based on the selected advertisement and the target route according to a user input for selecting at least one advertisement among the plurality of advertisements.

6. A method of controlling a user terminal, the method comprising:
obtaining, by the user terminal, at least one candidate route based on real-time data related to a location of the user terminal and a zone-specific floating population;
providing, by the user terminal, information about the candidate route; and
upon receiving a user input for selecting the candidate route as a target route from a user, generating, by the user terminal, a mission for the user based on the target route and at least one advertisement registered for a zone including at least a part of the target route.

7. A system for providing an advertising platform, the system comprising:
a display device that outputs an advertisement; and
a server that communicates with the display device and communicates with a user terminal of a user carrying the display device,
wherein the server is configured to:
obtain at least one candidate route based on real-time data related to a location of the user terminal and a zone-specific floating population;
transmit information about the candidate route to the user terminal; and
upon receiving a user input for selecting the candidate route as a target route, generate a mission for the user based on the target route and at least one advertisement registered for a zone including at least a part of the target route; and
when the mission for the user is generated, output the advertisement through the display device.
